(19) United States
(12) Patent Application Publication
(10) Pub. No.: US 2022/0165175 A1
(43) Pub. Date: May 26, 2022

(54) SYSTEM FOR VISUALLY REPRESENTING MUSICAL TIMING

(71) Applicants: Heather Pickett, Salt Lake City, UT (US); June Anne Little, Salt Lake City, UT (US)

(72) Inventors: Heather Pickett, Salt Lake City, UT (US); June Anne Little, Salt Lake City, UT (US)

(21) Appl. No.: 17/532,346

(22) Filed: Nov. 22, 2021

Related U.S. Application Data
(60) Provisional application No. 63/117,098, filed on Nov. 23, 2020.

(51) Int. Cl. G09B 15/02; G10G 1/00; G09B 1/04

(52) U.S. Cl. CPC G09B 15/026; G09B 1/04; G10G 1/00

(57) ABSTRACT

A system for visually representing musical timing includes a time signature spacer tile associated with a particular time signature and comprising a physical length based on the particular time signature. The system also includes one or more note tiles that have physical note tile lengths that correspond to different types of musical notes with different temporal note durations. The system also includes a tray that has a horizontal length. The tray is configured to receive the time signature spacer tile and a sequence of one or more note tiles of the plurality of note tiles. A combination of the time signature spacer tile and the sequence of note tiles substantially fills the horizontal length of the tray. A combined physical length of the sequence of note tiles corresponds to a combined temporal note duration that corresponds to a measure associated with the particular time signature.

### CROSS-REFERENCE TO RELATED APPLICATIONS

This application claims priority to and the benefit of U.S. Provisional Patent Application No. 63/117,098, filed Nov. 23, 2020, the entirety of which is incorporated herein by this reference.

### BACKGROUND

Musical notation can take on many forms for visually representing music that is playable with instruments or sung by the human voice. Modern staff notation is widely used by musicians and includes an arrangement of parallel lines, such as five horizontally extending parallel lines. The staff acts as a framework whereon pitch may be indicated by placing musical notes (e.g., note heads) on or between the lines. Musical notes are typically ordered on a staff from left to right such that users read the staff from left to right to understand the music represented on the staff. Different types of musical notes may be associated with different note durations (or note lengths).

To assist users in performing or playing a piece of music, modern staff notation often includes staffs that are divided into measures (or bars) separated by vertical lines along the staffs. Modern staff notation also often includes a time signature that may assist users in using the measures to accurately “keep time” when performing a piece of music. A time signature is often represented as a set of vertically arranged numbers where the lower number indicates a note value that represents a single beat and the upper number indicates how many beats form a measure.

Many users find it difficult to learn how to read or use modern staff notation. For example, many students of music find difficulty in understanding or gaining intuition for the temporal duration of different notes and measures associated with different time signatures. Consequently, they may have difficulty understanding or accurately playing or singing different musical notes relative to different measures and/or time signatures.

Accordingly, there are a number of difficulties associated with helping users understand musical timing that can be addressed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments of the present disclosure extend to systems, apparatuses, and components for visually representing musical timing.

For example, a system for visually representing musical timing includes a time signature spacer tile associated with a particular time signature and comprising a physical time signature spacer tile length based on the particular time signature. The system also includes a plurality of note tiles and/or a plurality of rest tiles. The note tiles include at least two note tiles that have different physical note tile lengths that correspond to different types of musical notes with different temporal durations, or in some instances can include a single note tile (such as when a note tile corresponding to a whole note is utilized). The rest tiles include at least two rest tiles that have different physical rest tile lengths that correspond to different types of musical rests with different temporal durations, or in some instances can include a single rest tile (such as when a rest tile corresponding to a whole rest is utilized).

The system also includes a tray that has a horizontal length. The tray is configured to receive the time signature spacer tile and a sequence of tiles of the plurality of note and/or rest tiles. A combination of the time signature spacer tile and the sequence of note and/or rest tiles substantially fills the horizontal length of the tray. A combined physical length of the sequence of note and/or rest tiles corresponds to a combined temporal duration for a measure associated with the particular time signature.

In another example, with features that may optionally be combined with the foregoing embodiment, a system for visually representing musical timing (and particularly the rhythmic and/or verbal counting of music) includes a tray and a measure counting tile associated with a particular time signature. The measure counting tile is sized to fit within and extend along the tray, and the measure counting tile includes a plurality of subdivisions. A number of subdivisions in the measure counting tile corresponds to a number of beats in a measure for the particular time signature. In some embodiments, one or more of the subdivisions may include indicators that further divide the subdivision. The indicators correspond to sub-beats (e.g., downbeats and upbeats or other subdivided beats) within the subdivision.

The system also includes a plurality of note tiles configured to arrange within the tray adjacent to the measure counting tile. Each of the note tiles includes a physical note tile length that corresponds to a different type of musical note. Each of the plurality of note tiles is configured to align with the plurality of subdivisions of the measure counting tile within the tray to visually depict temporal note duration for the different types of musical notes relative to beats associated with the particular time signature.

The system also includes a plurality of rest tiles configured to arrange within the tray adjacent to the measure counting tile. The rest tiles include physical rest tile lengths that correspond to different rest durations. Each of the rest tiles is configured to align with the plurality of subdivisions of the measure counting tile within the tray to visually depict temporal rest duration for the different types of rests relative to beats associated with the particular time signature.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an example system for visually representing musical timing where the system is closed;

FIG. 2 illustrates the example system for visually representing musical timing where the system is open exposing various components thereof;

FIGS. 3-6 illustrate the example system for visually representing musical timing that includes a time signature spacer tile and a measure counting tile associated with a

$$\begin{matrix}4 \\ 4\end{matrix}$$

time signature disposed within a tray along with various note and rest tiles;

FIGS. 7 and 8 illustrate an example system for visually representing musical timing that includes a time signature spacer tile and a measure counting tile associated with a

$$\begin{matrix}4 \\ 4\end{matrix}$$

time signature disposed within a tray along with various note and rest tiles, where the measure counting tile includes depictions of upbeats;

FIG. 9 illustrates an example system for visually representing musical timing that includes a time signature spacer tile and a measure counting tile associated with a

$$\begin{matrix}4 \\ 4\end{matrix}$$

time signature disposed within a tray along with various note and rest tiles, where the measure counting tile includes depictions of subdivided beats;

FIG. 10 illustrates an example system for visually representing musical timing that includes a time signature spacer tile and a measure counting tile associated with a

$$\begin{matrix}3 \\ 4\end{matrix}$$

time signature disposed within a tray along with various note tiles;

FIG. 11 illustrates an example system for visually representing musical timing that includes a time signature spacer tile and a measure counting tile associated with a

$$\begin{matrix}3 \\ 4\end{matrix}$$

time signature disposed within a tray along with various note tiles, where the measure counting tile includes depictions of subdivided beats;

FIG. 12 illustrates an example system for visually representing musical timing that includes a time signature spacer tile and a measure counting tile associated with a

$$\begin{matrix}3 \\ 4\end{matrix}$$

time signature disposed within a tray along with various note tiles, where the measure counting tile includes depictions of subdivided beats;

FIG. 13 illustrates an example system for visually representing musical timing that includes a time signature spacer tile and a measure counting tile associated with a

$$\begin{matrix}6 \\ 8\end{matrix}$$

time signature disposed within a tray along with various note tiles;

FIG. 14 illustrates an example system for visually representing musical timing that includes a time signature spacer tile and a measure counting tile associated with a

$$\begin{matrix}6 \\ 8\end{matrix}$$

time signature disposed within a tray along with various note tiles, where the measure counting tile includes depictions of subdivided beats; and

FIGS. 15-17 illustrate an example system for visually representing musical timing that includes various clef tiles, guide tiles, and alternative note tiles.

### DETAILED DESCRIPTION

Embodiments of the present disclosure extend to systems, apparatuses, and components for visually representing musical timing.

For example, a system for visually representing musical timing includes a spacer tile associated with a particular time signature and comprising a physical time signature spacer tile length that varies based on the particular time signature. The system also includes a plurality of note and/or rest tiles. The note and rest tiles include at least two note tiles and at least two rest tiles that have different physical lengths that correspond to different types of musical notes or rests with different temporal durations, or in some instances include a single note tile and/or rest tile, such as when a whole note tile or whole rest tile are utilized.

The system also includes a tray that has a horizontal length. The tray is configured to receive the time signature spacer tile and a sequence of note and/or rest tiles. A combination of the time signature spacer tile and the sequence of note and/or rest tiles substantially fills the horizontal length of the tray. A combined physical length of the sequence of note and/or rest tiles, when placed within the tray along with the time signature spacer tile, corresponds to a combined temporal duration that corresponds to a measure associated with the particular time signature.

In another example, with features that may be optionally combined with the foregoing example, a system for visually representing musical timing includes a tray and a measure counting tile associated with a particular time signature. The measure counting tile is sized to fit within and extend along the tray (e.g., along the top or bottom of the tray), and the measure counting tile includes a plurality of subdivisions. A number of subdivisions of the plurality of subdivisions corresponds to a number of beats in a measure for the particular time signature. In some embodiments, one or more of the subdivisions may include indicators that further divide the subdivision. The indicators correspond to sub-beats (e.g., downbeats and upbeats or other subdivided beats) within the subdivision.

The system also includes a plurality of note tiles configured to arrange within the tray and adjacent to the measure counting tile. Each of the note tiles includes a physical tile length that corresponds to a different type of musical note. Each of the note tiles is configured to align with the plurality of subdivisions of the measure counting tile within the tray to visually depict temporal note duration for the different types of musical notes relative to beats associated with the particular time signature.

The system also includes a plurality of rest tiles configured to arrange within the tray and adjacent to the measure counting tile. Each of the rest tiles includes a physical tile length that corresponds to a different type of musical rest. Each of the rest tiles is configured to align with the plurality of subdivisions of the measure counting tile within the tray to visually depict temporal duration for the different types of musical rests relative to beats associated with the particular time signature.

As used herein, the term “note tile” can generally refer to both sounded notes and rests, or it may refer to just a sounded note, depending on context.

The embodiments disclosed and claimed herein can assist users in understanding musical timing in an advantageous manner. For example, the trays of the systems disclosed herein can be configured to receive a time signature spacer tile (associated with a particular time signature). The time signature spacer tile may occupy a certain amount of horizontal space of the tray, and the remaining horizontal space of the tray may be configured to receive an arrangement of note and/or rest tiles. The note and rest tiles may have lengths that correspond to the relative note or rest durations represented by the note or rest tiles. For instance, a whole note tile may have a length that is four times greater than a length of a quarter note tile. A half rest tile may have a length that is two times greater than a length of a quarter rest tile.

In this regard, the horizontal length of the time signature spacer tile may be selected such that the horizontal space that remains in the tray when the time signature spacer tile is placed therein is configured to receive a combination of note and/or rest tiles that have a combined length that corresponds to a combined time duration. The combined time duration may correspond to or match a measure duration for the time signature associated with the time signature spacer tile. For example, for a time signature spacer tile associated with a

$$\begin{matrix}4 \\ 4\end{matrix}$$

time signature, the horizontal space that remains in the tray after the time signature spacer tile is placed therein may receive a single whole note and/or whole rest tile, four quarter note tiles and/or combination of four note and rest tiles, eight eighth note tiles, etc., whereas the remaining horizontal space may fail to accommodate note and/or rest tile combinations that durationally exceed a whole note (or measure).

Thus, users may interact with a system for visually representing musical timing, according to the present disclosure, to gain an understanding and/or intuition for how the durations of various musical notes and rests relate to various types of measures for various time signatures.

Furthermore, a system for visually representing musical timing may include measure counting tiles that provide visual representations of beats for measures associated with various time signatures. The measure counting tiles may be arranged adjacent to the time signature spacer tiles and/or note tiles of the system such that the note and/or rest tiles align with beat representations of the measure counting tiles. Such an arrangement may allow users to gain understanding and/or intuition of the note duration of different notes and/or rests relative to beats associated with different time signatures.

Additionally, in some instances, a system for visually representing musical timing may also provide additional functionality for aiding users in understanding and/or learning musical notation for different pitches associated with different clefs.

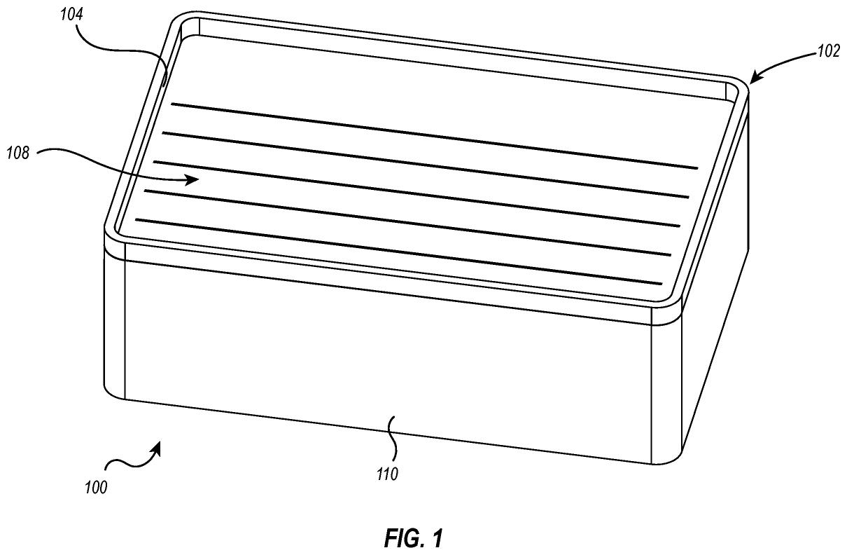

FIG. 1 illustrates an example system 100 for visually representing musical timing. FIG. 1 shows that, in some instances, the system 100 includes a tray 102 that optionally (but preferably) includes raised edges 104 and a tray platform 106. In the example shown in FIG. 1, the tray 102 includes a depiction of a staff 108 represented by horizontal lines disposed on the platform 106 of the tray 102 and extending horizontally to span a horizontal length of the tray 102 (e.g., a horizontal length of the platform 106 of the tray 102). As will be described herein, the tray may be configured to receive various tiles for visually representing musical timing to users.

FIG. 1 also illustrates a container 110 that can be configured to receive the tray 102 as a lid therefor. For example, the raised edges 104 of the tray 102 may comprise ridges that are configured to rest over edges of an opening of the container 110 to allow the platform 106 of the tray 102 to cover the opening of the container 110, as shown in FIG. 1.

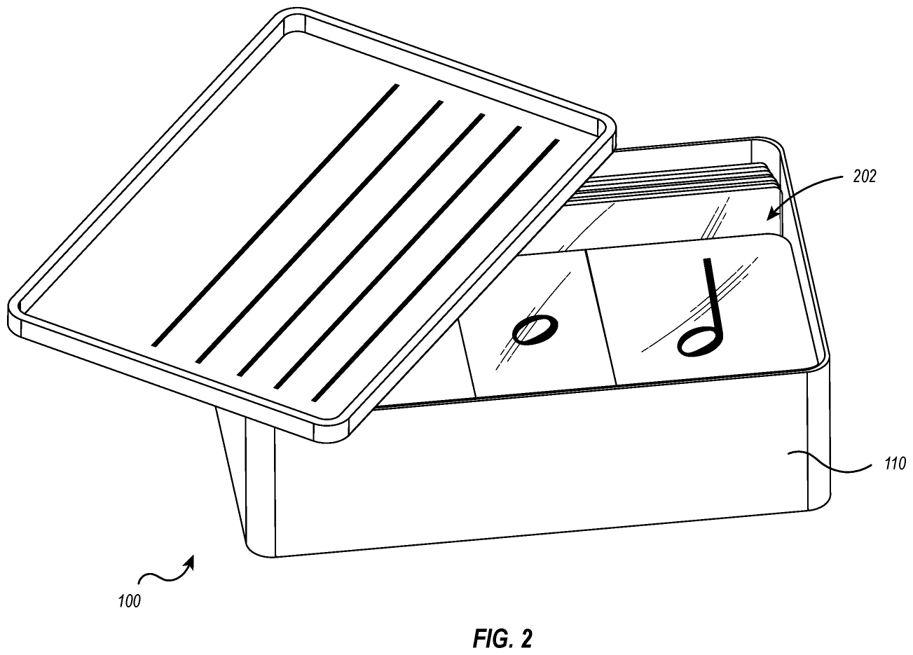

FIG. 2 illustrates an example of the container 110 with the tray 102 removed therefrom to expose an opening 202 of the container 110. FIG. 2 shows that, in some implementations, the container 110 is configured to house various components of the system 100 for visually representing musical timing. For example, the container 110 may house note time signature spacer tiles, note tiles, rest tiles, measure counting tiles, clef tiles, guide tiles, alternative note tiles, and/or other components, which will now be described with additional detail.

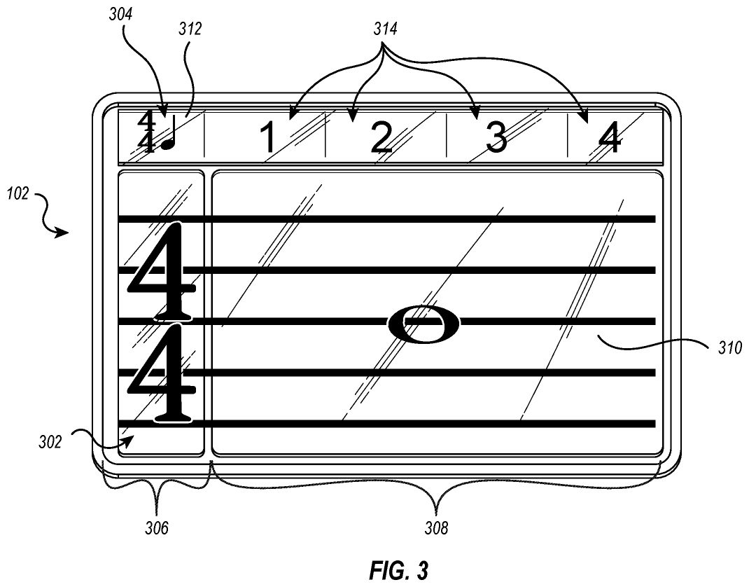

FIGS. 3-6 illustrate the tray 102 of the system 100 for visually representing musical timing with various tiles disposed therein. In particular, the tray 102 is illustrated in FIGS. 3-6 as having a time signature spacer tile 302 and a measure counting tile 304 positioned therein (e.g., on the platform 106). FIGS. 3-6 illustrate implementations in which the time signature spacer tile 302 and the measure counting tile 304 are associated with a

$$\begin{matrix}4 \\ 4\end{matrix}$$

time signature. This is indicated in FIGS. 3-6 by the

$$\begin{matrix}4 \\ 4\end{matrix}$$

time signature being depicted on the time signature spacer tile 302 and the measure counting tile 304.

In some instances, the time signature spacer tile length 306 of the time signature spacer tile 302 depends on the time signature that is associated with the time signature spacer tile 302. For example, the time signature spacer tile 302, which is associated with a

$$\begin{matrix}4 \\ 4\end{matrix}$$

time signature, may have a time signature spacer tile length 306 that is smaller than a time signature spacer tile length of other time signature spacer tiles associated with different time signatures, such as

$$\begin{matrix}3 \\ 4\end{matrix} or \begin{matrix}6 \\ 8\end{matrix}$$

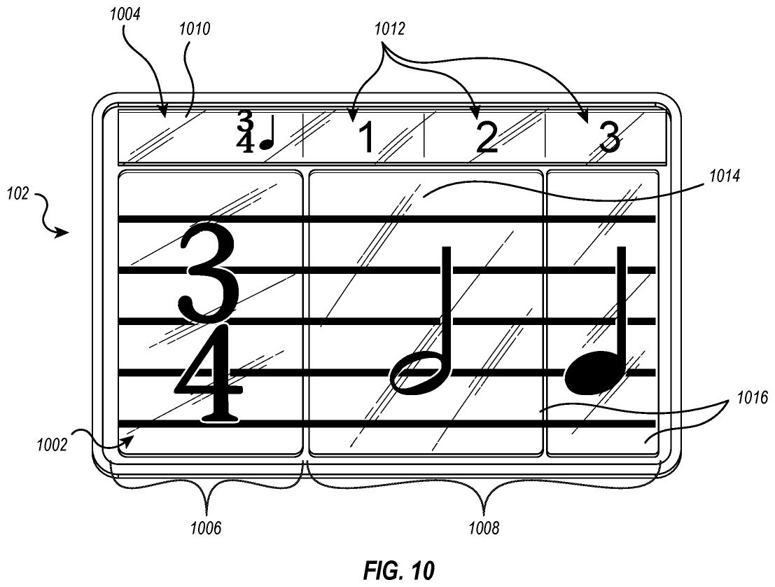

(see, for example, FIGS. 10-14).

In this regard, when the time signature spacer tile 302 is positioned within the tray 102 as shown in FIG. 3, the remaining horizontal space 308 within the tray 102 (e.g., between the time signature spacer tile 302 and an opposing edge 104 of the tray 102) may also depend on the time signature associated with the time signature spacer tile 302 (e.g.,

$$\begin{matrix}4 \\ 4\end{matrix}$$

for FIG. 3). This remaining horizontal space 308 within the tray 102 may be configured to receive various note and/or rest tiles, as shown in FIGS. 3-6. The various note and/or rest tiles of a system 100 may have different tile lengths that correspond to different types of musical notes and/or rest that have different time durations.

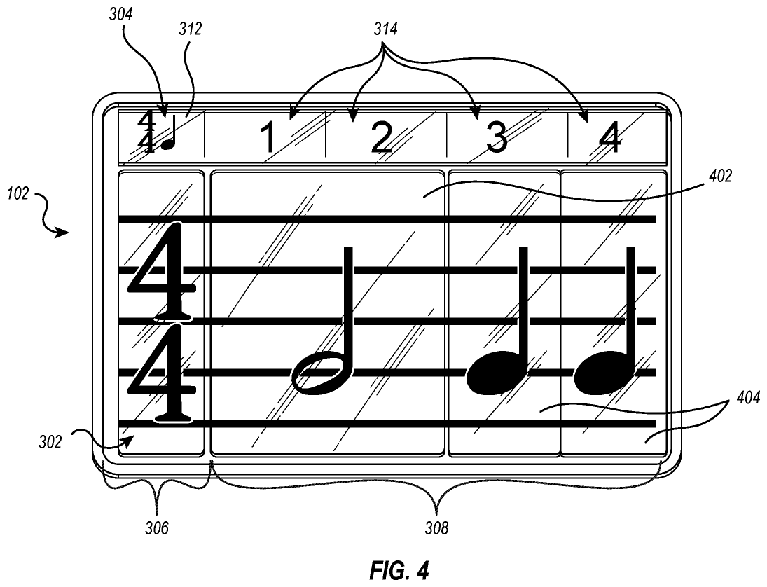

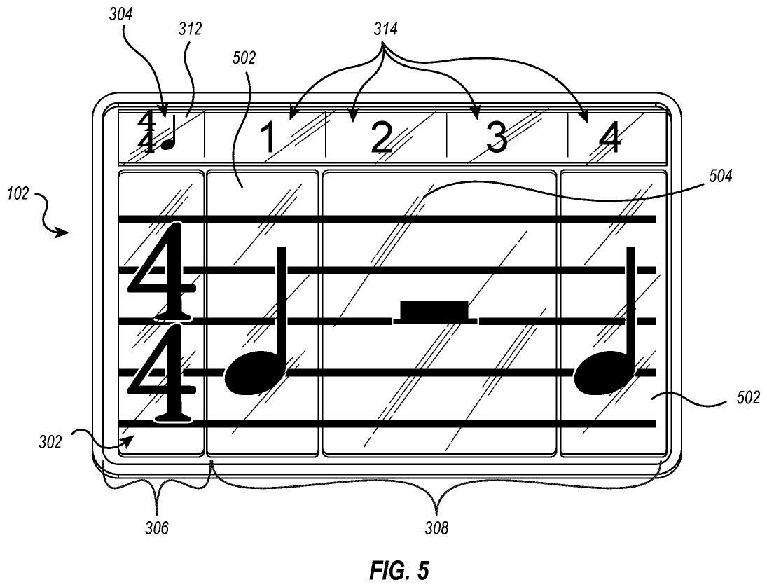

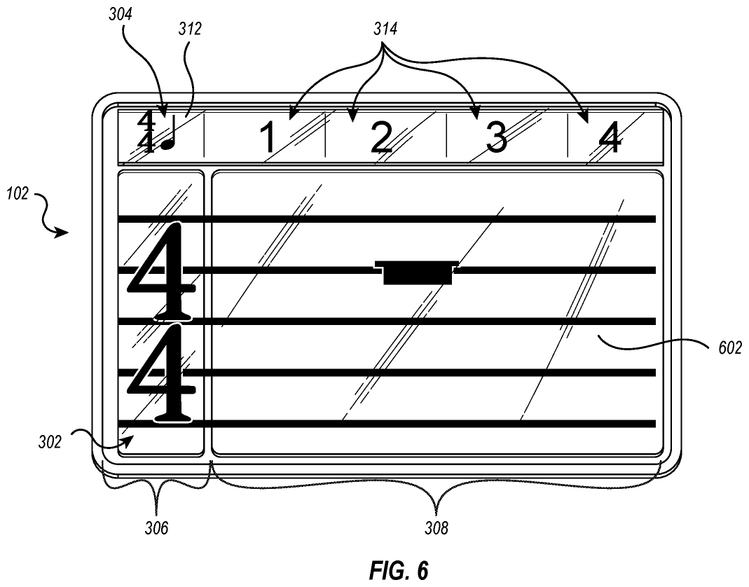

For example, FIG. 3 shows a whole note tile 310 disposed within the remaining horizontal space 308, FIG. 4 shows a linear arrangement of a half note tile 402 and two quarter note tiles 404 disposed within the remaining horizontal space 308. FIG. 5 shows a linear arrangement of two quarter note tiles 502 and a half note rest tile 504 disposed within the remaining horizontal space 308. FIG. 6 shows a whole note rest tile 602 disposed within the remaining horizontal space 308. Of the note tiles depicted in FIGS. 3-6, the note tiles associated with the longest notes, such as whole note tile 310 and whole note rest tile 602, have the longest note tile lengths, whereas the note tiles associated with the shortest notes, such as quarter note tiles 404 and 502, have the shortest note tile lengths. Also, the note tiles associated with intermediate note durations, such as half note tile 402 and half note rest tile 504, have corresponding intermediate note tile lengths. That is, the half note tile 402 and half note rest tile 504 have note tile lengths that are approximately half of the note tile lengths of whole note tile 310 and whole note rest tile 602, whereas the quarter note tiles 404 and 502 have note tile lengths that are approximately one quarter of the note tile lengths of whole note tile 310 and whole note rest tile 602.

FIGS. 3-6 illustrate implementations in which the various sequences of note tiles that follow the time signature spacer tile 302 substantially fill the remaining horizontal space 308 within the tray 102. FIGS. 3-6 also illustrate that the different sequences of note tiles that follow the time signature spacer tile 302 each have a combined note duration that corresponds to the duration of a measure for the particular time signature associated with the time signature spacer tile 302. For example, as noted above, the time signature spacer tile 302 is associated with a

$$\begin{matrix}4 \\ 4\end{matrix}$$

time signature, for which a measure has a duration of four beats (indicated by the top numeral in the time signature) of quarter notes (indicated by the bottom numeral in the time signature), or a duration of a whole note. Thus, the remaining horizontal space 308 formed within the tray 102 when the time signature spacer tile 302 is positioned as shown in FIGS. 3-6 may be configured to receive a combination of note tiles with a combined duration of a whole note (i.e., with a combined duration equal to a

$$\begin{matrix}4 \\ 4\end{matrix}$$

time measure).

For instance, the whole note tile 310 of FIG. 3 occupies the substantial entirety of the remaining horizontal space 308, the combination of the half note tile 402 and two quarter note tiles 404 of FIG. 4 occupy the substantial entirety of the remaining horizontal space 308, the combination of the two quarter note tiles 502 and a half note rest tile 504 of FIG. 5 occupy the substantial entirety of the remaining horizontal space 308, and the whole note rest tile 602 of FIG. 6 occupies the substantial entirety of the remaining horizontal space 308.

In this regard, the relative horizontal lengths of the tray 102, the various time signature spacer tiles of the system 100 (e.g., time signature spacer tile 302), and the various note tiles of the system 100 (e.g., whole note tile 310, half note tiles 402 and 502, quarter note tiles 404 and 502, half note rest tile 504, whole note rest tile 602, and/or others) may be specifically configured such that the horizontal length/space that remains within the tray 102 when a time signature spacer tile is positioned therein (e.g., adjacent to an edge 104 of the tray 102) is configured to receive a sequence of note tiles that form a combined horizontal physical length that corresponds to a combined temporal note duration, where the combined temporal note duration corresponds to the temporal duration of a measure associated with the particular time signature for the time signature spacer tile (e.g.,

$$\begin{matrix}4 \\ 4\end{matrix} ,$$

with a measure duration of a whole note).

In this way, users may arrange different combinations of note tiles within the tray 102 with different time signature spacer tiles (associated with different time signatures) to obtain visual representations of the temporal duration of musical notes relative to different measures associated with different time signatures. Such visual representations may help users to gain understanding and/or intuition for the temporal duration of musical notes relative to different measures associated with different time signatures. For example, a user may gain understanding that a particular arrangement of note tiles results in a combined note duration (represented by physical horizontal length) that is smaller than, the same as, or greater than the temporal duration of a measure for a particular time signature, thereby increasing understanding of different combinations of notes that may occupy the temporal space of a measure according to modern staff notation.

As indicated hereinabove, FIGS. 3-6 include a measure counting tile 304 that is configured to fit within and extend along the horizontal length of the tray 102. FIGS. 3-6 illustrate the measure counting tile 304 positioned within the tray and adjacent to the time signature spacer tile 302 and the various combinations of note tiles that fill the remaining horizontal space 308. As illustrated in FIGS. 3-6, the measure counting tile 304 includes a spacer portion 312. Similar to the time signature spacer tile length 306 described hereinabove, the length of the spacer portion 312 of the measure counting tile 304 may also be based on the time signature associated with the measure counting tile. Thus, in some instances, the length of the spacer portion 312 of a measure counting tile 304 associated with a particular time signature is the same as the time signature spacer tile length 306 of a time signature spacer tile 302 associated with the same particular time signature (e.g.,

$$\begin{matrix}4 \\ 4\end{matrix} ,$$

as shown in FIGS. 3-6). For example, the spacer portion 312 of the measure counting tile 304, which is associated with a

$$\begin{matrix}4 \\ 4\end{matrix}$$

time signature, may have a length that is smaller than spacer portions of measure counting tiles associated with different time signatures, such as

$$\begin{matrix}3 \\ 4\end{matrix} or \begin{matrix}6 \\ 8\end{matrix}$$

(see, for example, FIGS. 10-14).

In some implementations, such as those shown in FIGS. 3-6, the spacer portion 312 of the measure counting tile 304 is configured to align within the tray 102 with the time signature spacer tile 302 (e.g., where both the measure counting tile 304 and the time signature spacer tile 302 are associated with the same time signature). FIGS. 3-6 also show that the measure counting tile 304 includes a plurality of subdivisions 314, which are representative of the beats that form a measure for the time signature associated with the measure counting tile 304. For example, the measure counting tile 304 of FIGS. 3-6 is associated with a

$$\begin{matrix}4 \\ 4\end{matrix}$$

time signature, which includes 4 beats (indicated by the top numeral). Accordingly, the plurality of subdivisions 314 of the measure counting tile 304 includes four subdivisions. As shown in FIGS. 3-6, the various subdivisions of the plurality of subdivisions 314 also include numerical depictions of ordinal beat number (e.g., 1, 2, 3, 4).

In this way, the plurality of subdivisions 314 of the measure counting tile 304 may be thought of as dividing the remaining horizontal space 308 into sections based on the number of beats that form a measure for the time signature associated with the measure counting tile 304 (e.g., a

$$\begin{matrix}4 \\ 4\end{matrix}$$

time signature). Also, the length of the various subdivisions of the plurality of subdivisions 314 may be thought of as depending on the note duration that represents one beat for the time signature associated with the measure counting tile (e.g., a quarter note). For example, FIG. 4 illustrates the quarter note tiles 402 as having a length that is substantially the same as the length of the subdivisions of the plurality of subdivisions 314.

Accordingly, users may arrange various configurations of note tiles within the tray 102 adjacent to the plurality of subdivisions 314 of the measure counting tile 304 (as shown in FIGS. 3-6) to obtain visual representations of the temporal duration of musical notes relative to beats of measures associated with different time signatures. Such visual representations may help users to gain understanding and/or intuition for the temporal duration of musical notes relative to beats of measures associated with different time signatures. For example, a user may gain understanding that particular note tiles or combinations of note tile result in a note duration (represented by physical horizontal length) that is smaller than, the same as, or greater than durations associated with various beats.

Although FIGS. 3-6 focus, in at least some respects, on particular selections of note tiles, as well as a time signature spacer tile 302 and a measure counting tile 304 associated with a

$$\begin{matrix}4 \\ 4\end{matrix}$$

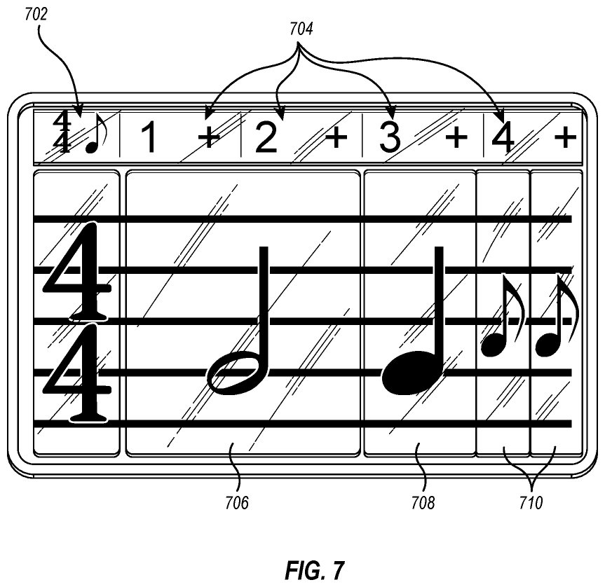

time signature, FIGS. 7-14 illustrate that a system 100 can include additional or alternative types of note tiles, time signature spacer tiles, and/or measure counting tiles to help users learn musical timing using visual representations thereof.

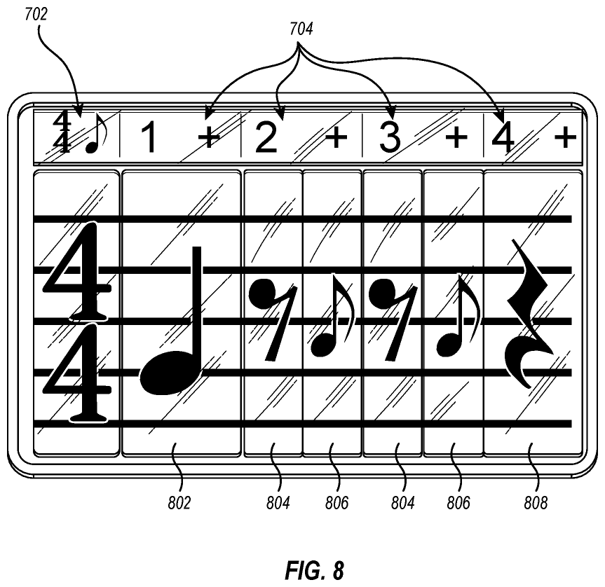

For instance, FIGS. 7 and 8 illustrate configurations for a system 100 that include a measure counting tile 702 associated with a

$$\begin{matrix}4 \\ 4\end{matrix}$$

time signature that includes depictions of upbeats in the subdivisions of the plurality of subdivisions 704 of the measure counting tile 702. The subdivisions of the plurality of subdivisions 704 may thus be regarded as being subdivided into downbeats (indicated by the numeric depictions of the subdivisions) and upbeats (indicated by “+” symbols).

The measure counting tile 702 may allow users to gain understanding and/or intuition of note durations for different notes (represented by the physical horizontal lengths of note tiles) relative to beats subdivided into downbeats and upbeats. For example, FIG. 7 illustrates a half note tile 706 that spans two subdivisions (e.g., spanning two downbeats and two upbeats), a quarter note tile 708 that spans one subdivision (e.g., spanning one downbeat and one upbeat), and two eighth note tiles 710 that each span one half of one subdivision (e.g., spanning only one downbeat and one upbeat, respectively).

FIG. 8 illustrates a quarter note tile 802 that spans one subdivision (e.g., spanning one downbeat and one upbeat), two eighth note rest tiles 804 that each span one half of a subdivision (e.g., each spanning a single, separate downbeat), two eighth note tiles 806 that each span one half of a subdivision (e.g., each spanning a single, separate upbeat), and a quarter note rest tile 808 that spans one subdivision (e.g., spanning one downbeat and one upbeat).

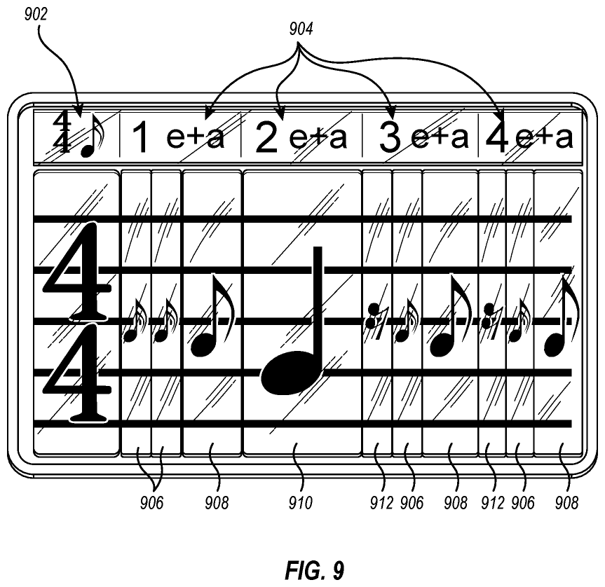

FIG. 9 illustrates a configuration for a system 100 that includes a measure counting tile 902 associated with a

$$\begin{matrix}4 \\ 4\end{matrix}$$

time signature where the subdivisions of the plurality of subdivisions 904 of the measure counting tile 902 are further subdivided into downbeats (indicated by numeric depictions), upbeats (indicated by “+” symbols), and intermediate subdivisions of “ee” and “uh” (indicated by “e” and “a” depictions). The subdivisions of the plurality of subdivisions 904, which are representative of a quarter note duration for a

$$\begin{matrix}4 \\ 4\end{matrix}$$

time signature, may thus be regarded as being further subdivided into sixteenth note durations (e.g., 1 e+a, where each element “1”, “e”, “+”, and “a” represents one sixteenth note duration, and so forth).

The measure counting tile 902 may allow users to gain understanding and/or intuition of note durations for different notes (represented by the physical horizontal lengths of note tiles) relative to beats subdivided into downbeats, upbeats, and further subdivisions. For example, FIG. 9 illustrates several sixteenth note tiles 906 that each span a quarter of a subdivision (e.g., spanning only one of a “1”, “e”, “+”, or “a”), several eighth note tiles 908 that each span a half of a subdivision (e.g., spanning any pair of adjacent sixteenth note duration subdivisions, such as “1 e”, “e+”, “+a”, “a 2”, and so forth), a quarter note tile 910 that spans a full subdivision (e.g., spanning any set of four adjacent sixteenth note duration subdivisions, such as “1 e+a”, “e+a 2”, “+a 2 e”, “a 2 e+”, and so forth), and sixteenth note rest tiles 912 that each span a quarter of a subdivision (e.g., spanning only one of a “1”, “e”, “+”, or “a”).

Although FIGS. 3-9 have focused, in at least some respects, on configurations in which a system includes time signature spacer tiles and/or measure counting tiles that are associated with a

$$\begin{matrix}4 \\ 4\end{matrix}$$

time signature, FIGS. 10-14 demonstrate that a system 100 include time signature spacer tiles and/or measure counting tiles associated with different time signatures.

For example, FIG. 10 illustrates an example of a system 100 that includes a time signature spacer tile 1002 associated with a

$$\begin{matrix}3 \\ 4\end{matrix}$$

time signature positioned within the tray 102. The tray 102 also includes a measure counting tile 1004 disposed therein that is also associated with a

$$\begin{matrix}3 \\ 4\end{matrix}$$

time signature. As noted above, a system 100 may represent temporal duration with horizontal physical length, and a measure duration for a

$$\begin{matrix}3 \\ 4\end{matrix}$$

time signature includes three quarter note beats, whereas a measure duration for a

$$\begin{matrix}4 \\ 4\end{matrix}$$

time signature includes four quarter note beats. Thus, as is evident from FIG. 10, the time signature spacer tile length 1006 of the time signature spacer tile 1002 is larger than the time signature spacer tile length 306 of the time signature spacer tile 302 associated with a

$$\begin{matrix}4 \\ 4\end{matrix}$$

time signature, as shown and described hereinabove with reference to FIGS. 3-6.

Furthermore, in view of the time signature spacer tile length 1006 being larger than the time signature spacer tile length 306, the remaining horizontal space 1008 within the tray 102 when the time signature spacer tile 1002 is positioned within the tray is smaller than the remaining horizontal space 308 associated with the time signature spacer tile 302 described hereinabove. For example, with a time signature spacer tile 1002 associated with a

$$\begin{matrix}3 \\ 4\end{matrix}$$

time signature arranged within the tray as shown in FIG. 10, the remaining horizontal space 1008 within the tray may be configured to receive a sequence of note tiles that have a combined note duration that corresponds to the duration of a measure for the

$$\begin{matrix}3 \\ 4\end{matrix}$$

time signature, which is the duration of three quarter notes. By way of example, FIG. 10 illustrates a sequence of note tiles filling the remaining horizontal space 1008 that includes a half note tile 1014 and a quarter note tile 1016.

Similarly, the length of the spacer portion 1010 of the measure counting tile 1004 is larger than the length of the spacer portion 312 of the measure counting tile 304 for the same reasons as those discussed above. However, the subdivisions of the plurality of subdivisions 1012 of the measure counting tile 1004 have a same length as the subdivisions of the plurality of subdivisions 314 of the measure counting tile 304 discussed above, in particular because both pluralities of subdivisions 1012 and 314 are representative of quarter note beat durations.

Measure counting tiles associated with a

$$\begin{matrix}3 \\ 4\end{matrix}$$

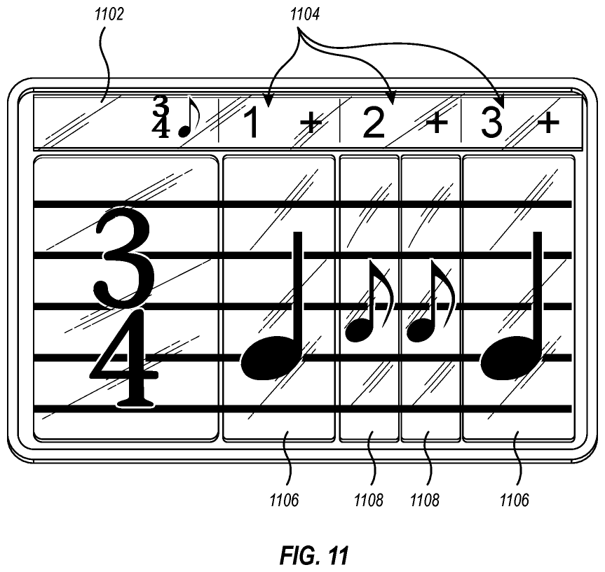

time signature may also include subdivisions that provide granular beat divisions. For example, FIG. 11 illustrates a system 100 that includes a measure counting tile 1102 that includes depictions of both downbeats (indicated by numerical depictions) upbeats (indicated by “+” symbols) in the subdivisions of the plurality of subdivisions 1104 of the measure counting tile 1002.

The measure counting tile 1102 may allow users to gain understanding and/or intuition of note durations for different notes (represented by the physical horizontal lengths of note tiles) relative to beats subdivided into downbeats and upbeats for a

$$\begin{matrix}3 \\ 4\end{matrix}$$

time signature. For example, FIG. 11 illustrates quarter note tiles 1106 that each span one subdivision (e.g., each spanning a consecutive downbeat and upbeat), and eighth note tiles 1108 that each span one half of one subdivision (e.g., spanning only one downbeat and one upbeat).

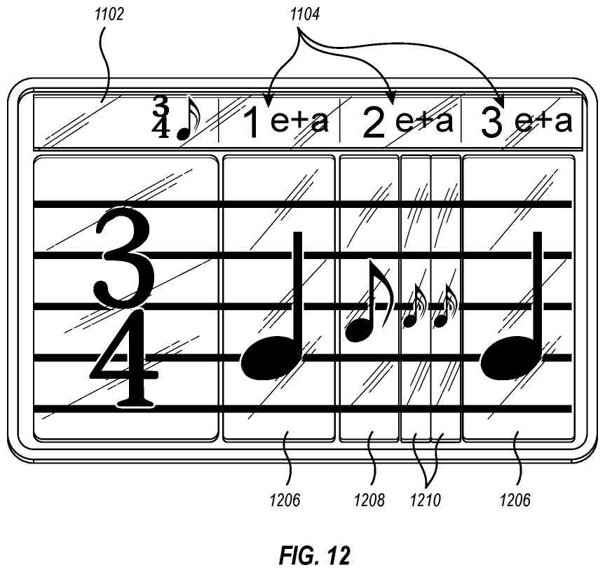

As another example, FIG. 12 illustrates a configuration for a system 100 that includes a measure counting tile 1202 associated with a

$$\begin{matrix}3 \\ 4\end{matrix}$$

time signature where the subdivisions of the plurality of subdivisions 1204 of the measure counting tile 1202 are further subdivided into downbeats (indicated by numeric depictions), upbeats (indicated by “+” symbols), and intermediate subdivisions of “ee” and “uh” (indicated by “e” and “a” depictions). The subdivisions of the plurality of subdivisions 1204, which are representative of a quarter note duration for a

$$\begin{matrix}3 \\ 4\end{matrix}$$

time signature, may thus be regarded as being further subdivided into sixteenth note durations (e.g., 1 e+a, where each element “1”, “e”, “+”, and “a” represents one sixteenth note duration, and so forth).

The measure counting tile 1202 may allow users to gain understanding and/or intuition of note durations for different notes (represented by the physical horizontal lengths of note tiles) relative to beats subdivided into downbeats, upbeats, and further subdivisions for a

$$\begin{matrix}3 \\ 4\end{matrix}$$

time signature. For example, FIG. 12 illustrates quarter note tiles 1206 that each span a full subdivision (e.g., spanning any set of four adjacent sixteenth note duration subdivisions, such as “1 e+a”, “e+a 2”, “+a 2 e”, “a 2 e+”, and so forth), an eighth note tile 1208 that spans a half of a subdivision (e.g., spanning any pair of adjacent sixteenth note duration subdivisions, such as “1 e”, “e+”, “+a”, “a 2”, and so forth), and sixteenth note tiles 1210 that each span a quarter of a subdivision (e.g., spanning only one of a “1”, “e”, “+”, or “a”).

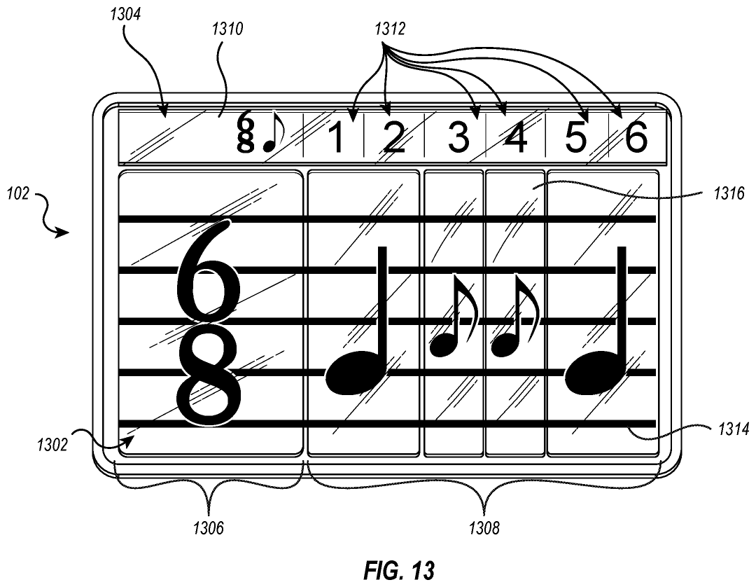

FIG. 13 illustrates an example of a system 100 that includes a time signature spacer tile 1302 associated with a

$$\begin{matrix}6 \\ 8\end{matrix}$$

time signature positioned within the tray 102. The tray 102 also includes a measure counting tile 1304 disposed therein that is also associated with a

$$\begin{matrix}6 \\ 8\end{matrix}$$

time signature. As noted above, a system 100 may represent temporal duration with horizontal physical length, and a measure duration for a

$$\begin{matrix}6 \\ 8\end{matrix}$$

time signature includes six eighth note beats, which corresponds in duration to a measure for a

$$\begin{matrix}3 \\ 4\end{matrix}$$

time signature that includes three quarter note beats. Thus, as is evident from FIG. 13, the time signature spacer tile length 1306 of the time signature spacer tile 1302 is substantially the same as the time signature spacer tile length 1006 of the time signature spacer tile 1002 associated with a

$$\begin{matrix}3 \\ 4\end{matrix}$$

time signature, as shown and described hereinabove with reference to FIGS. 10-12.

Furthermore, in view of the time signature spacer tile length 1306 being substantially the same as the time signature spacer tile length 1006, the remaining horizontal space 1308 within the tray 102 when the time signature spacer tile 1302 is positioned within the tray 102 is substantially the same as the remaining horizontal space 1008 associated with the time signature spacer tile 1002 described hereinabove. For example, with a time signature spacer tile 1302 associated with a

$$\begin{matrix}6 \\ 8\end{matrix}$$

time signature arranged within the tray as shown in FIG. 13, the remaining horizontal space 1308 within the tray 102 may be configured to receive a sequence of note tiles that have a combined note duration that corresponds to the duration of a measure for the

$$\begin{matrix}6 \\ 8\end{matrix}$$

time signature, which is the duration of six eighth notes (which is the same duration as three quarter notes for a measure according to a

$$\begin{matrix}3 \\ 4\end{matrix}$$

time signature). By way of example, FIG. 13 illustrates a sequence of note tiles filling the remaining horizontal space 1308 that includes two quarter note tiles 1314 and two eighth note tiles 1316.

The length of the spacer portion 1310 of the measure counting tile 1304 is substantially the same as the length of the spacer portion 1010 of the measure counting tile 1004 for the same reasons as those discussed above. Although measure durations are the same for a

$$\begin{matrix}6 \\ 8\end{matrix}$$

time signature and a

$$\begin{matrix}3 \\ 4\end{matrix}$$

time signature, the number of beats is different. For example, the subdivisions of the plurality of subdivisions 1312 of the measure counting tile 1304 have different length than the subdivisions of the plurality of subdivisions 1012 of the measure counting tile 1004 discussed above, in particular because the subdivisions of the plurality of subdivisions 1312 of the measure counting tile 1304 are representative of an eighth note duration (e.g., according to a

$$\begin{matrix}6 \\ 8\end{matrix}$$

time signature) and the subdivisions of the plurality of subdivisions 1012 of the measure counting tile 1004 are representative of a quarter note duration (e.g., according to a

$$\begin{matrix}3 \\ 4\end{matrix}$$

time signature).

Thus, a system 100 with a measure counting tile 1304 and a time signature spacer tile 1304 arranged as depicted in FIG. 13 may allow users to gain understanding and/or intuition for the temporal relationship between the note durations of various note types (represented by physical horizontal length of note tiles) and beat duration for a

$$\begin{matrix}6 \\ 8\end{matrix}$$

time signature.

Measure counting tiles associated with a

$$\begin{matrix}6 \\ 8\end{matrix}$$

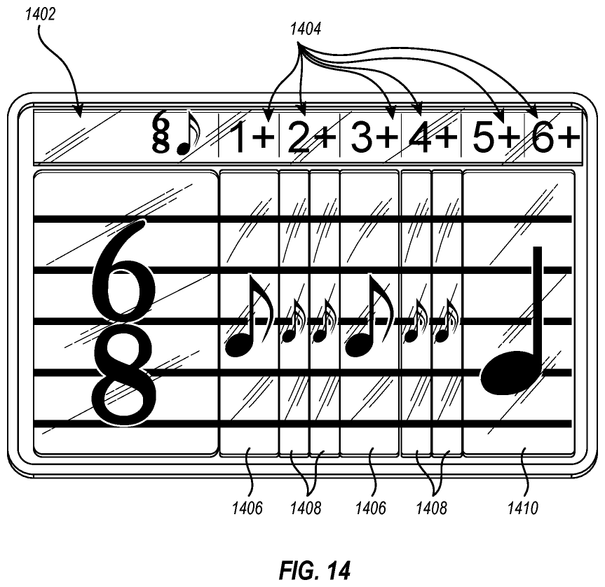

time signature may also include subdivisions that provide granular beat divisions. For example, FIG. 14 illustrates a system 100 that includes a measure counting tile 1402 that includes depictions of both downbeats (indicated by numerical depictions) upbeats (indicated by “+” symbols) in the subdivisions of the plurality of subdivisions 1404 of the measure counting tile 1402. By depicting both downbeats and upbeats for beats of a measure for a

$$\begin{matrix}6 \\ 8\end{matrix}$$

time signature, the measure counting tile 1402 provides sixteenth note beat granularity.

The measure counting tile 1402 may allow users to gain understanding and/or intuition of note durations for different notes (represented by the physical horizontal lengths of note tiles) relative to beats subdivided into downbeats and upbeats for a

$$\begin{matrix}6 \\ 8\end{matrix}$$

time signature. For example, FIG. 14 illustrates eighth note tiles 1406 that each span one subdivision (e.g., spanning any pair of adjacent sixteenth note duration subdivisions, such as “1+”, “+2”, and so forth), sixteenth note tiles 1408 that each span a half of a subdivision (e.g., spanning only one of a “1”, “+” and so forth), and a quarter note tile 1410 that spans two adjacent subdivisions (e.g., spanning any set of four adjacent sixteenth note duration components, such as “1+2+”, “+2+3”, and so forth).

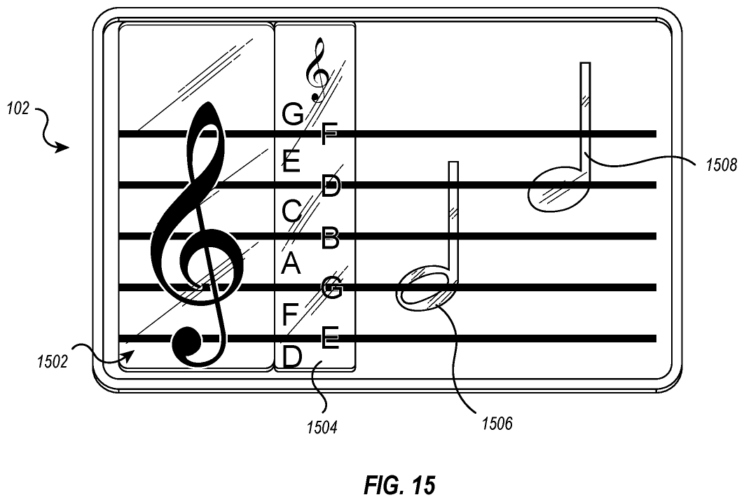

FIGS. 15-17 illustrate an example additional use of a system 100 according to the present disclosure. For example, FIGS. 15-17 illustrate that a system can include various clef tiles, guide tiles, and alternative note tiles. FIG. 15 shows a G-clef tile 1502 (or treble clef tile) arranged within the tray 102 with a G-clef guide tile 1504 and various alternative note tiles (an alternative half note tile 1506 and an alternative quarter note tile 1508). The G-clef guide tile 1504 provides indications of the different pitches associated with the different horizontal lines and spaces of a staff according to the G-clef. A user may thus arrange various sequences or combinations of alternative note tiles on the various horizontal lines and spaces of the staff 108 of the tray 102 to generate exercises in which a user is challenged to produce (e.g., via human voice or musical instrument) the pitch indicated by the horizontal lines or spaces on which the alternative note tile(s) is/are arranged. For example, for early learning, the G-clef guide tile 1504 may be used in combination with the G-clef tile 1502, whereas for more advanced learning, the G-clef guide tile 1504 may be removed.

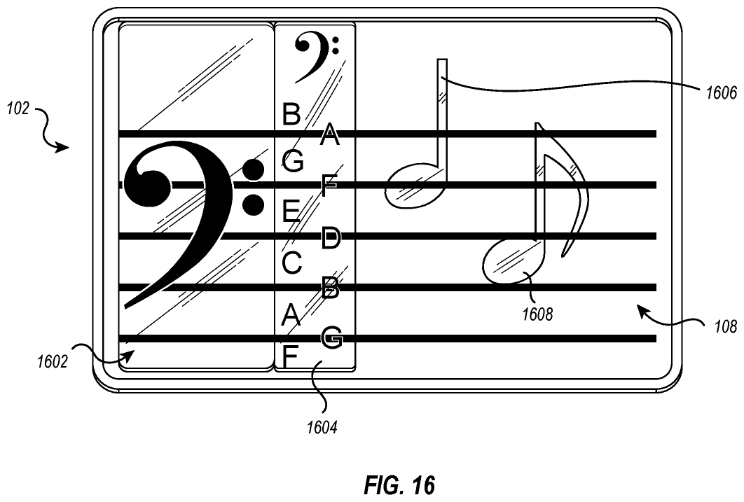

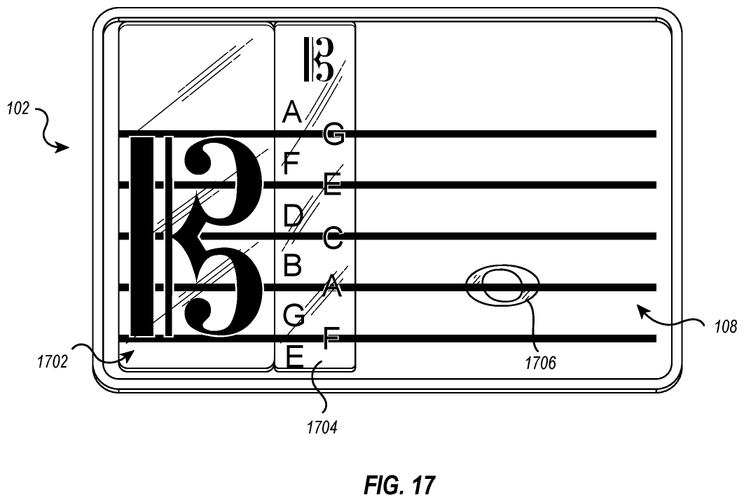

Similar functionality may be facilitated by the system 100 for clefs other than the G-clef. For example, FIG. 16 illustrates an F-clef tile 1602 (or bass clef tile) arranged within the tray 102 with an F-clef guide tile 1604 and various alternative note tiles (an alternative quarter note tile 1606 and an alternative eighth note tile 1608). The F-clef guide tile 1604 provides indications of the different pitches associated with the different horizontal lines and spaces of a staff according to the F-clef. Similarly, FIG. 17 illustrates a C-clef tile 1702 (or alto clef tile) arranged within the tray 102 with a C-clef guide tile 1704 and an alternative note tiles (an alternative whole note tile 1706). The C-clef guide tile 1704 provides indications of the different pitches associated with the different horizontal lines and spaces of a staff according to the C-clef.

Although the present disclosure focuses, in at least some respects, on various tiles that are at least partially transparent, it will be appreciated, in view of the present disclosure, that tiles can be made opaque, translucent, or with any other light transmitting or reflecting properties.

Furthermore, it should be noted that at least some tiles of the present disclosure may comprise different colors. In some instances, the colors may advantageously convey patterns that underly musical timing to users. For example, tiles associated with quarter note durations may be presented in yellow, such as the measure counting tile (where the beats that underly the measure counting tile 304 comprise a quarter note duration), quarter note tiles, quarter note rest tile, and alternative quarter note tiles. Thus, users may associate the color yellow with quarter note timing for learning purposes. Similarly, tiles associated with whole note durations may be presented in blue, tiles associated with half note durations may be presented in green, tiles associated with eighth note duration may be presented in red, and tiles associated with sixteenth note duration may be presented in orange. The particular selection of colors described above is provided by way of example only, and, in some implementations, no coherent color scheme exists in the system.

Similarly, the coloring of the measure counting tiles may be made to correspond to the coloring of the various note tiles based on the granularity of the beat divisions indicated by the measure counting tiles. For example, where each beat, and thus each subdivision, corresponds to a quarter note, the measure counting tile may be colored similar to the quarter note tiles. Where the measure counting tile is further divided to indicate sub-beats, the measure counting tile may be colored similar to the note tiles that match the most granular sub-beat of the measure counting tile. For example, where each subdivision of the measure counting tile includes indicators for a downbeat and an upbeat, the most granular sub-beat of the measure counting tile is an eighth note. The measure counting tile can therefore be colored similar to the eighth note tiles. In another example, where each subdivision of the measure counting tile includes intermediate subdivisions corresponding to a sixteenth note, the measure counting tile can be colored similar to the sixteenth note tiles.

In addition, although the present disclosure only depicts certain types of musical notes in the Figures, those skilled in the art will recognize, in view of the present disclosure, that any type of musical note (e.g., dotted half notes, triplets, etc.), time signature, beat or beat subdivision, measure, clef, etc. may be represented by a system for visually representing musical timing according to the present disclosure. Furthermore, it will be appreciated, in view of the present disclosure, that the particular physical tile configurations (e.g., horizontal length) shown herein are illustrative only and non-limiting.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for visually representing musical timing, comprising:
a time signature spacer tile associated with a particular time signature and comprising a time signature spacer tile length based on the particular time signature;
one or more note tiles each having a length that corresponds to a type of musical note with a corresponding note duration; and
a tray comprising a horizontal length, the tray being configured to receive the time signature spacer tile and a sequence of one or more note tiles, wherein a combination of the time signature spacer tile and the sequence of note tiles substantially fills the horizontal length of the tray, and wherein a combined length of the sequence of note tiles corresponds to a combined note duration that corresponds to a measure associated with the particular time signature.

2. The system of claim 1, wherein the time signature spacer tile comprises a depiction of the particular time signature.

3. The system of claim 1, wherein the tray comprises a depiction of a staff.

4. The system of claim 1, wherein the tray comprises raised edges.

5. The system of claim 1, wherein the one or more note tiles comprises at least two note tiles having different note tile lengths, and optionally wherein the at least two note tiles comprise different colors.

6. The system of claim 1, further comprising a container configured to arrange under the tray such that the tray forms a lid for the container.

7. The system of claim 6, wherein the container is configured to house the time signature spacer tile and the one or more note tiles.

8. The system of claim 1, further comprising a plurality of time signature spacer tiles, at least two of the plurality of time signature spacer tiles being associated with different particular time signatures and comprising different time signature spacer tile lengths.

9. The system of claim 1, further comprising:
a measure counting tile associated with the particular time signature, the measure counting tile sized to fit within and extend along the horizontal length of the tray, the measure counting tile comprising a plurality of subdivisions,
wherein a number of subdivisions of the plurality of subdivisions corresponds to a number of beats in the measure associated with the particular time signature, and
wherein the sequence of note tiles is configured to arrange within the tray adjacent to the plurality of subdivisions to visually depict note duration for the different types of musical notes relative to beats associated with the particular time signature.

10. The system of claim 9, wherein the measure counting tile comprises a spacer portion, and wherein a length of the spacer portion is based on the number of beats in a measure for the particular time signature, and wherein the spacer portion is configured to align with the time signature spacer tile within the tray.

11. The system of claim 9, wherein a length of subdivisions of the plurality of subdivisions corresponds to a note duration that represents one beat for the particular time signature.

12. The system of claim 9, wherein the measure counting tile comprises a depiction of the particular time signature.

13. The system of claim 9, wherein each of the plurality of subdivisions comprises a depiction of a beat number.

14. The system of claim 9, further comprising a plurality of measure counting tiles, at least two of the plurality of measure counting tiles being associated with different particular time signatures and comprising different pluralities of subdivisions that differ in subdivision length or beat notation.

15. The system of claim 9, wherein one or more of the one or more note tiles, the time signature spacer tile, or the measure counting tile is at least partially transparent.

16. The system of claim 9, wherein the measure counting tile is colored according to a note tile matching a beat granularity of the measure counting tile.

17. A system for visually representing musical timing, comprising:
a tray;
a measure counting tile associated with a particular time signature, the measure counting tile sized to fit within and extend along the tray, the measure counting tile comprising a plurality of subdivisions, wherein a number of subdivisions of the plurality of subdivisions corresponds to a number of beats in a measure for the particular time signature; and
a plurality of note tiles configured to arrange within the tray and adjacent to the measure counting tile, each of the plurality of note tiles comprising a note tile length that corresponds to a different type of musical note, wherein each of the plurality of note tiles is configured to align with the plurality of subdivisions of the measure counting tile within the tray to visually depict note duration for the different types of musical notes relative to beats associated with the particular time signature.

18. The system of claim 17, wherein the measure counting tile comprises a spacer portion, and wherein a length of the spacer portion is based on the number of beats in a measure for the particular time signature.

19. The system of claim 17, further comprising a time signature spacer tile configured to arrange within the tray adjacent to the spacer portion of the measure counting tile, the time signature spacer tile comprising a time signature spacer tile length that corresponds to the length of the spacer portion such that, when the measure counting tile and the time signature spacer tile are arranged within the tray with the time signature spacer tile positioned adjacent to the spacer portion, a remaining horizontal space within the tray is sized to receive a sequence of note tiles of the plurality of note tiles that form a composite length that corresponds to a combined note duration that corresponds to a measure associated with the particular time signature.
